(19) United States
(12) Patent Application Publication
(10) Pub. No.: US 2006/0104087 A1
(43) Pub. Date: May 18, 2006

(54) Direct type backlight module with high heat dissipating efficiency

(75) Inventor: Charles Leu, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/242,098

(22) Filed: Oct. 3, 2005

(30) Foreign Application Priority Data
Nov. 12, 2004 (TW) 93134600

(51) Int. Cl. F21V 7/04

(52) U.S. Cl. 362/600

(57) ABSTRACT

A direct type backlight module (100) includes a housing (110), a reflection plate (130), a diffusion plate (120) and a plurality of lamps (140). The housing includes a window portion (113), a base portion (111) and a side portion (112). The side portion is located between edges (114) of the window portion and the base portion. The reflection plate is positioned in the housing, supported by the side portion, thereby dividing the housing into a first room (150) and a second room (155). The diffusion plate is located at the window portion of the housing. The lamps are positioned in the first room, between the diffusion plate and the reflection plate. A plurality of openings (170a, 170b) are defined in the side portion and communicate with the first room. Forced cooling air (172) is introduced into the first room to dissipate accumulated heat therefrom and into the external environment.

### BACKGROUND

1. Field of the Invention

The invention relates generally to direct type backlight modules and, more particularly, to a direct type backlight module with a high heat dissipating efficiency.

2. Description of the Related Art

Backlight modules are used in liquid crystal display devices for converting linear light sources such as cold cathode ray tubes or point light sources such as light emitting diodes into area light sources having high uniformity and brightness. Backlight modules generally include edge lighting backlight modules and direct type backlight modules. A typical edge light backlight module generally need requires a light guide plate, while a typical direct type backlight module does not need not a light guide plate, and thereby having has a relatively simple structure.

Referring to FIG. 2, a conventional direct type backlight module 50 used in a liquid crystal display 12 includes a lower diffusion plate 16, a brightness enhancement film 20, an upper diffusion plate 22, a reflection plate 58, a heat dissipating plate 59, and a plurality of lamps 14. The reflection plate 58 includes a bottom surface 58a and a side surface 58b. A plurality of first through apertures 62a are defined in the bottom surface 58a, and a plurality of second through apertures 64 are defined in the side surface 58b. The lower diffusion plate 16 is mounted on the reflection plate 58, and cooperates with the reflection plate 58 to define a first chamber 60. The lamps 14 are positioned in the first chamber 60 corresponding to the first through apertures 62a. The heat dissipating plate 59 is positioned below the reflection plate 58, and cooperates with the reflection plate 58 to define a second chamber 70. The heat dissipating plate 59 is combined with a housing 54, which and together are pressed into a fin type structure 54a. The second chamber 70 communicates with the first through apertures 62a and the second through apertures 64. The brightness enhancement film 20 is mounted on the lower diffusion plate 16, and the upper diffusion plate 22 is mounted on the brightness enhancement film 20.

In use, heat produced by the lamps 14 can be transferred to the heat dissipating plate 59 via air convection between the first chamber 60 and the second chamber 70. Thus, the heat can be dissipated into the external environment via the fin type structure 54a. However, the means of air convection has a relatively small thermal conductivity coefficient, and, as such, a heat dissipating velocity thereof is slow. After a long time working, the heat accumulated in the backlight module 50 can't be transferred to the heat dissipating plate 59 in time, and, accordingly, the heat can't be dissipated into the external environment effectively.

What is needed, therefore, is a direct type backlight module having high heat dissipating efficiency.

### SUMMARY

In one embodiment, a direct type backlight module includes a housing, a reflection plate, a diffusion plate and a plurality of lamps. The housing includes a window portion, a base portion and a side portion located between edges of the window portion and the base portion. The reflection plate is positioned in the housing, supported by the side portion, thereby dividing the housing into a first room and a second room. The diffusion plate is located at the window portion of the housing. The lamps are positioned in the first room, between the diffusion plate and the reflection plate. A plurality of openings is defined in the side portion, and each opening communicates with the first room.

Furthermore, a film is coated on a surface of the diffusion plate that faces the lamps. The film is advantageously formed by alternately depositing silicon dioxide and titanium trioxide via ion-beam assisted deposition and/or plasma sputtering deposition.

Compared with a conventional direct type backlight module, the inventive direct type backlight module has the following advantages. Firstly, forced cooling air can be introduced into the first room via the openings to dissipate accumulated heat therefrom and into the external environment effectively. This forced air flow ensures that the inventive direct type backlight module has a high heat dissipating efficiency. Secondly, as only visible light can pass through the film on the diffusion plate, heat produced by the lamps is restricted in the first room and can not pass through the film in the form of infrared light waves. Thus, a liquid crystal display device incorporating the inventive direct type backlight module can have good imaging quality. Furthermore, since the heat produced by the lamps can be effectively dissipated into the external environment by the forced cooling air introduced into the first room, the direct type backlight module can be advantageously applied in liquid crystal display devices.

Other advantages and novel features will become more apparent from the following detailed description of preferred embodiments when taken in conjunction with the accompanying drawings.

### BRIEF DESCRIPTION OF THE DRAWINGS

The above-mentioned and other features and advantages of the invention, and the manner of attaining them, will become more apparent and the invention will be better understood by reference to the following description of embodiments of the invention taken in conjunction with the accompanying drawings, wherein:

FIG. 1 is a schematic, cross-sectional view of a direct type backlight module in accordance with a embodiment of the present invention; and

FIG. 2 is a schematic, cross-sectional view of a conventional direct type backlight module of the prior art.

Corresponding reference characters indicate corresponding parts throughout the several views. The exemplifications set out herein illustrate at least one preferred embodiment of the invention, in one form, and such exemplifications are not to be construed as limiting the scope of the invention in any manner.

### DETAILED DESCRIPTION OF PREFERRED EMBODIMENTS

Reference will now be made to the drawings to describe embodiments of the present invention in detail.

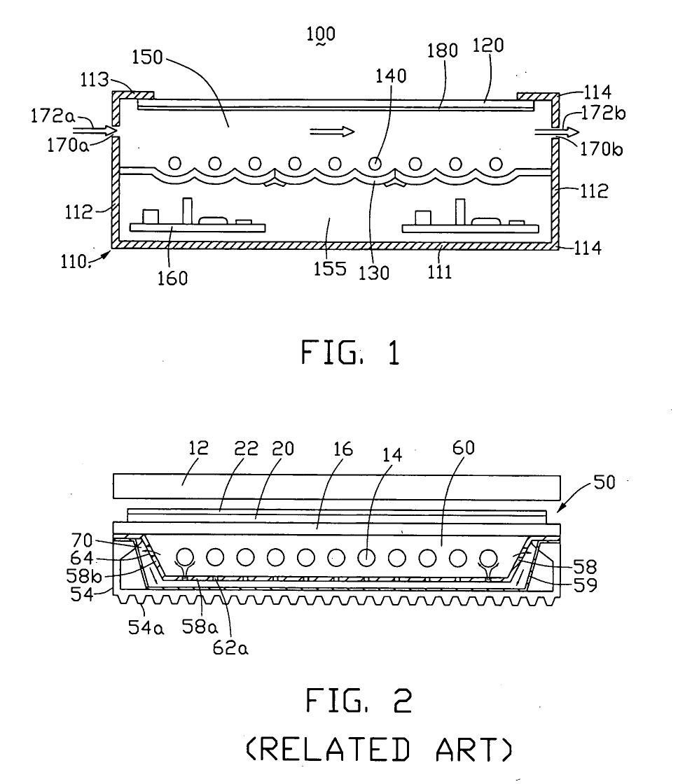

Referring to FIG. 1, a direct type backlight module 100 includes a housing 110, a reflection plate 130, a diffusion plate 120, a plurality of lamps 140 and a circuit assembly 160. The housing 110 includes a window portion 113, a base portion 111 and a side portion 112. The side portion 112 is located between respective edges 114 of the window portion 113 and the base portion 111. The reflection plate 130 is positioned in the housing 110, supported by the side portion 112, thereby dividing the housing 110 into a first room 150 and a second room 155. The diffusion plate 120 is located at the window portion 113 of the housing 110. The lamps 140 are cold cathode fluorescent lamps and are positioned in the first room 150, between the diffusion plate 120 and the reflection plate 130. The circuit assembly 160 is positioned in the second room 155 and is electrically connected with the lamps 140. A plurality of openings 170a, 170b are defined in the side portion 112 and communicate with the first room 150. A source of forced cooling air, schematically indicated at 172, can be introduced into the first room 150 via the openings 170a to dissipate accumulated heat therefrom and into the external environment effectively via the opening 170b.

In the embodiment, the reflection plate 130 is rippled and/or undulated, thereby increasing resistance of the forced cooling air 172 flowing therealong. This increased airflow resistance results in refluence (i.e., back flow or reflux) of the forced cooling air 172, thereby enhancing the utilization ratio of the forced cooling air 172 in the first room 150. Thus, a cooling efficiency of the forced cooling air 172 is enhanced.

Furthermore, a film 180 is coated on a surface of the diffusion plate 120 and faces the lamps 140. The film 180 is advantageously formed by alternately depositing silicon dioxide and titanium trioxide via ion-beam assisted deposition and/or plasma sputtering deposition. A thickness of every silicon dioxide layer is in the approximate range of from 73 to 185 nanometers, and a thickness of every titanium trioxide layer is about in the range of from 80 to 115 nanometers. Only visible light having a wavelength generally in the range from 370 to 700 nanometers can pass through the film 180. Therefore, heat produced by the lamps 140 is restricted in the first room 150, the heat being incapable of passing through the film 180 in the form of infrared light waves. Thus, a liquid crystal display device incorporating the direct type backlight module 100 can have good imaging quality. Furthermore, the heat produced by the lamps 140 can be readily dissipated into the external environment by the forced cooling air 172. Therefore, the direct type backlight module 100 can be advantageously applied in liquid crystal display devices.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

We claim:

1. A direct type backlight module comprising:
a housing having a window portion, a base portion and a side portion, the side portion being located between the window portion and the base portion;
a reflection plate positioned in the housing and dividing the housing into a first room and a second room;
a diffusion plate located at the window portion of the housing;
a plurality of lamps positioned in the first room, between the diffusion plate and the reflection plate; and
a plurality of openings defined in the side portion of the housing, the openings each communicating with the first room of the housing.

2. The direct type backlight module as claimed in claim 1, further comprising a circuit assembly electrically connected with the lamps.

3. The direct type backlight module as claimed in claim 1, wherein the lamps are cold cathode fluorescent lamps.

4. The direct type backlight module as claimed in claim 1, further comprising a film coated on the diffusion plate and facing the lamps, the film only allowing visible light to pass therethrough.

5. The direct type backlight module as claimed in claim 4, wherein the film is formed of alternately deposited silicon dioxide and titanium trioxide.

6. The direct type backlight module as claimed in claim 5, wherein the silicon dioxide and titanium trioxide are deposited by means of ion-beam assisted deposition.

7. The direct type backlight module as claimed in claim 5, wherein the silicon dioxide and titanium trioxide are deposited by means of plasma sputtering deposition.

8. The direct type backlight module as claimed in claim 5, wherein a thickness of every silicon dioxide layer is in the approximate range of from 73 to 185 nanometers.

9. The direct type backlight module as claimed in claim 5, wherein a thickness of every titanium trioxide layer is about in the range of from 80 to 115 nanometers.

10. The direct type backlight module as claimed in claim 5, wherein the reflection plate is at least one of rippled and undulated.

11. The direct type backlight module as claimed in claim 1, wherein the direct type backlight module is configured for use in a liquid crystal display device.

12. A direct type backlight module comprising:
a housing having a window portion;
a reflection plate positioned in the housing and dividing the housing into a first room and a second room;
a diffusion plate located at the window portion of the housing;
a plurality of lamps positioned in the first room, between the diffusion plate and the reflection plate; and
a plurality of openings defined in the housing, the openings each communicating with the first room of the housing.

13. The direct type backlight module as claimed in claim 12, further comprising a source of forced cooling air, the plurality of openings and the first room being configured for receiving the forced cooling air therethrough.

14. The direct type backlight module as claimed in claim 12, further comprising a film coated on the diffusion plate and facing the lamps, the film only allowing visible light to pass therethrough.
